(19) United States
(12) Patent Application Publication
(10) Pub. No.: US 2014/0035898 A1
(43) Pub. Date: Feb. 6, 2014

(54) DRIVER IC MOUNTING BOARD, DISPLAY UNIT, AND PROJECTION DISPLAY UNIT

(71) Applicant: Sony Corporation, Tokyo (JP)

(72) Inventors: Noboru Toyozawa, Kanagawa (JP); Takashi Hirakawa, Kanagawa (JP); Taro Ichitsubo, Kanagawa (JP); Eiji Kato, Kanagawa (JP)

(73) Assignee: Sony Corporation, Tokyo (JP)

(21) Appl. No.: 13/952,012

(22) Filed: Jul. 26, 2013

(30) Foreign Application Priority Data
Aug. 6, 2012 (JP) 2012-174256

(51) Int. Cl. G09G 3/34

(52) U.S. Cl. CPC G09G 3/34
USPC 345/212; 345/84

(57) ABSTRACT

A driver IC includes: a plurality of driver circuits that are individually provided for respective light modulation elements and drive the light modulation elements, in which the light modulation elements each perform light modulation on received light in response to an applied voltage; and a plurality of output terminals outputting signals derived from the respective driver circuits to outside. The driver IC is a single driver IC that drives the light modulation elements. The output terminals are disposed on sides of the driver IC, and the respective output terminals are disposed on the different sides for the respective corresponding driver circuits.

### BACKGROUND

The present technology relates to a driver IC that drives a light modulation element, a mounting board including the driver IC, and a display unit and a projection display unit each including the mounting board.

A color-display projector has a liquid crystal panel as a light valve for each color of light. For example, a projector using light of three primary colors of red, green, and blue has three liquid crystal panels as light valves (for example, see Japanese Unexamined Patent Application Publication No. 2003-057674). The liquid crystal panels are separately driven by driver ICs provided for individual liquid crystal panels.

### SUMMARY

If the driver ICs are individually provided for the respective liquid crystal panels, areal occupancy of the driver ICs in a surface of a wiring substrate increases in proportion to the number of the driver ICs. In addition, if a plurality of driver ICs are mounted on a wiring substrate, a large number of wirings run around each driver IC, the wirings connecting the driver IC to various circuits that adjust output from the driver IC, for example. This results in an increase in areal occupancy of the wirings in a surface of the wiring substrate. In particular, if all of such wirings are formed in one layer on the wiring substrate, a wiring layout inevitably becomes extremely complicated.

It is desirable to provide a driver IC capable of simplifying a wiring layout around the driver IC, and reducing areal occupancy of wirings in a surface of a wiring substrate, a mounting board including the driver IC, and a display unit and a projection display unit each including the mounting board.

According to an embodiment of the present technology, there is provided a driver IC, including: a plurality of driver circuits that are individually provided for respective light modulation elements and drive the light modulation elements, the light modulation elements each performing light modulation on received light in response to an applied voltage; and a plurality of output terminals outputting signals derived from the respective driver circuits to outside. The driver IC is a single driver IC that drives the light modulation elements, and the output terminals are disposed on sides of the driver IC, and the respective output terminals are disposed on the different sides for the respective corresponding driver circuits.

According to an embodiment of the present technology, there is provided a mounting board, including a single driver IC mounted on a wiring substrate, the driver IC driving a plurality of light modulation elements, and the light modulation elements each performing light modulation on received light in response to an applied voltage. The driver IC includes a plurality of driver circuits that are individually provided for the respective light modulation elements and drive the light modulation elements, and a plurality of output terminals outputting signals derived from the respective driver circuits to outside. The output terminals are disposed on sides of the driver IC, and the respective output terminals are disposed on the different sides for the respective corresponding driver circuits.

According to an embodiment of the present technology, there is provided a display unit, including: a plurality of light modulation elements each performing light modulation on received light in response to an applied voltage; and a mounting board including a single driver IC mounted on a circuit substrate, the driver IC driving the light modulation elements. The mounting board includes a plurality of driver circuits that are individually provided for the respective light modulation elements, and drive the light modulation elements, and a plurality of output terminals outputting signals derived from the respective driver circuits to outside. The output terminals are disposed on sides of the driver IC, and the respective output terminals are disposed on the different sides for the respective corresponding driver circuits.

According to an embodiment of the present technology, there is provided a projection display unit, including: an illumination optical system; a plurality of light modulation elements each generating image light through modulation of light derived from the illumination optical system in response to an applied voltage; a mounting board including a single driver IC mounted on a circuit substrate, the driver IC driving the light modulation elements; and a projection optical system projecting the image light generated by the light modulation elements. The mounting board includes a plurality of driver circuits that are individually provided for the respective light modulation elements, and drive the light modulation elements, and a plurality of output terminals outputting signals derived from the respective driver circuits to outside. The output terminals are disposed on sides of the driver IC, and the respective output terminals are disposed on the different sides for the respective corresponding driver circuits.

In the driver IC, the mounting board, the display unit, and the projection display unit according to the above-described respective embodiments of the technology, the driver circuits are individually provided in the single driver IC for the respective light modulation elements. This reduces areal occupancy of the driver IC in a surface of the wiring substrate compared with a case where driver ICs are individually provided for respective light modulation elements. In the case where driver ICs are individually provided for respective light modulation elements, a large number of wirings are provided on a wiring substrate, the wirings connecting each driver IC to various circuits that adjust output from the driver IC, for example. In such a configuration, if all of such wirings are provided in one layer on the wiring substrate, a wiring layout becomes extremely complicated, and areal occupancy of the wirings increases in the surface of the wiring substrate. In contrast, in the above-described respective embodiments of the technology, since the plurality of driver circuits are incorporated in the single driver IC, the above-described various circuits are easily incorporated in the driver IC. Furthermore, in the above-described respective embodiments of the technology, the plurality of output terminals are separately disposed on the different sides for the respective corresponding driver circuits. This extremely simplifies the wiring layout around the driver IC, and reduces areal occupancy of the wirings in the surface of the wiring substrate.

According to the driver IC, the mounting board, the display unit, and the projection display unit of the above-described respective embodiments of the technology, the driver circuits are individually provided in the single driver IC for the respective light modulation elements, and the plurality of output terminals are separately disposed on the different sides for the respective corresponding driver circuits. Consequently, a wiring layout around the driver IC is simplified, and areal occupancy of wirings is reduced in a surface of a wiring substrate.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a diagram illustrating an exemplary schematic configuration of a display unit according to a first embodiment of the present technology.

FIG. 2 is a diagram illustrating an exemplary schematic configuration of a liquid crystal display panel (LCD) illustrated in FIG. 1.

FIG. 3 is a diagram illustrating an exemplary internal configuration of a driver IC illustrated in FIG. 1.

FIG. 4 is a diagram illustrating an exemplary internal configuration of a driver circuit illustrated in FIG. 3.

FIG. 5 is a diagram illustrating another exemplary internal configuration of the driver circuit illustrated in FIG. 3.

FIG. 6A is a diagram illustrating an example of appearance of the driver IC illustrated in FIG. 1.

FIG. 6B is a diagram illustrating another example of appearance of the driver IC illustrated in FIG. 1.

FIG. 7 is a diagram illustrating an exemplary surface layout of a mounting board including a wiring substrate on which the driver IC illustrated in FIG. 1 is mounted.

FIG. 8 is a diagram illustrating another exemplary surface layout of the mounting board including the circuit substrate on which the driver IC illustrated in FIG. 1 is mounted.

FIG. 9 is a diagram illustrating an exemplary internal configuration of an AC waveform conditioning circuit illustrated in FIG. 1.

FIG. 10 is a diagram for explaining conditioning by the AC waveform conditioning circuit illustrated in FIG. 1.

FIG. 11 is a diagram illustrating a Modification of a configuration of a display unit illustrated in FIG. 1.

FIG. 12 is a diagram illustrating an exemplary internal configuration of an amplifier circuit in the display unit illustrated in FIG. 11.

FIG. 13 is a diagram illustrating an exemplary output voltage from a temperature detection circuit illustrated in FIG. 11.

FIG. 14 is a diagram illustrating a Modification of the configuration of the display unit illustrated in FIG. 11.

FIG. 15 is a diagram illustrating an exemplary internal configuration of an amplifier circuit in the display unit illustrated in FIG. 14.

FIG. 16 is a diagram illustrating an exemplary peripheral circuit for a driver IC.

FIG. 17 is a diagram illustrating an exemplary internal configuration of an amplifier circuit in the case where the display unit illustrated in FIG. 1 includes a temperature detection circuit and a pull-up circuit.

FIG. 18 is a diagram illustrating an exemplary schematic configuration of a projector (projection display unit) according to a second embodiment of the present technology.

FIG. 19 is a diagram illustrating an exemplary schematic configuration of a projector (projection display unit) according to a third embodiment of the present technology.

### DETAILED DESCRIPTION

Hereinafter, some embodiments of the present technology are described in detail with reference to the accompanying drawings. It is to be noted that description is made in the following order.

1. First Embodiment (display unit)

2. Modification of First Embodiment (display unit)

3. Second Embodiment (projection display unit)

4. Third Embodiment (projection display unit)

### 1. First Embodiment

### [Configuration]

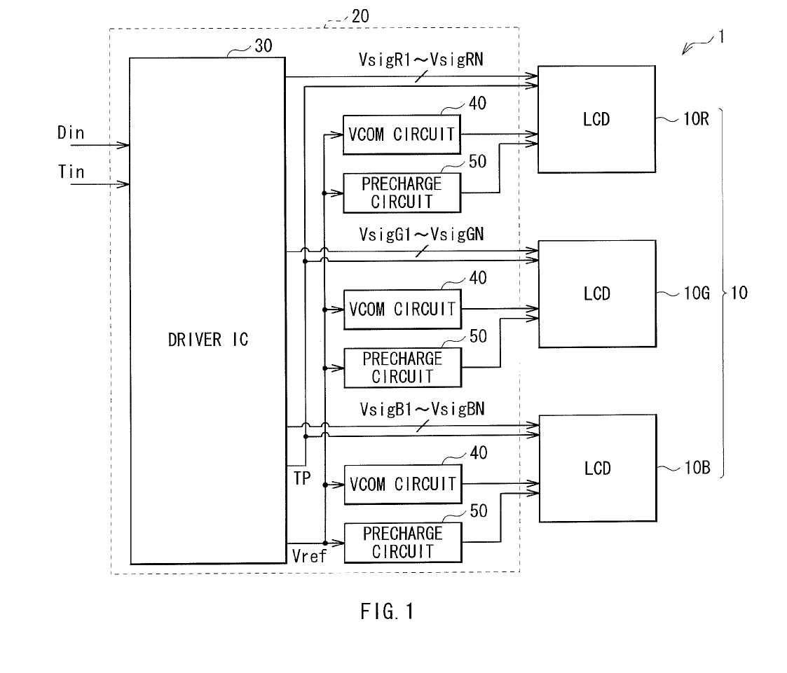

FIG. 1 illustrates a schematic configuration of a display unit 1 according to a first embodiment of the present technology. The display unit 1 may be applicable as a light valve for a three-plate-type projector (projection display unit). For example, the display unit 1 may include liquid crystal display (LCD) panels 10R, 10G, and 10B, and a drive circuit 20. It is to be noted that if the liquid crystal display panels 10R, 10G, and 10B are each of a transmission type, the display unit 1 includes an undepicted light source in the back of each of the liquid crystal display panels 10R, 10G, and 10B.

Hereinafter, a term “liquid crystal display panel 10” is used as a general term of the liquid crystal display panels 10R, 10G, and 10B. The liquid crystal display panels 10R, 10G, and 10B correspond to a specific but not limitative example of “a plurality of light modulation elements that each perform light modulation on received light in response to applied voltage” of one embodiment of the present technology.

### (Liquid Crystal Display Panel 10)

The liquid crystal display panel 10 electrically varies a polarizing state of light in response to applied voltage to generate image light, and, for example, may have a transmittance or reflectance characteristic of normally black. The liquid crystal display panel 10R modulates received light based on received red-color image signals VsigR1 to VsigRN to generate red-color image light. The liquid crystal display panel 10G modulates received light based on received green-color image signals VsigG1 to VsigGN to generate green-color image light. The liquid crystal display panel 10B modulates received light based on received blue-color image signals VsigB1 to VsigBN to generate blue-color image light. Hereinafter, a term “image signals Vsig1 to VsigN” is used as a general term of the image signals VsigR1 to VsigRN, VsigG1 to VsigGN, and VsigB1 to VsigBN.

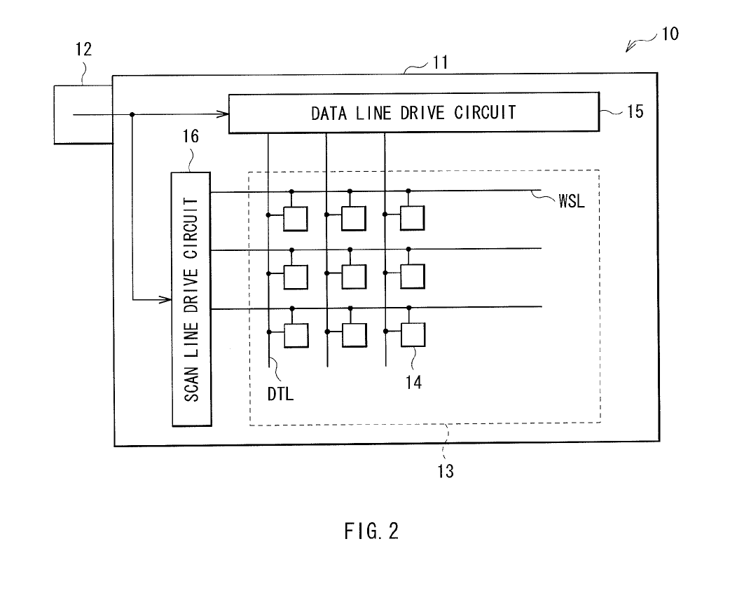

FIG. 2 illustrates an exemplary schematic configuration of a liquid crystal display panel 10 illustrated in FIG. 1. For example, the liquid crystal display panel 10 may include a panel section 11, and a flexible printed circuit (FPC) board 12 (hereinafter, referred to as FPC 12) connected to the panel section 11. For example, the panel section 11 may include a pixel region 13 having a plurality of pixels 14 formed in a matrix, a data line drive circuit 15, and a scan line drive circuit 16. In the panel section 11, each pixel 14 is subjected to active drive by the data line drive circuit 15 and the scan line drive circuit 16, thereby image light is generated based on digital image signals received from the outside.

The panel section 11 includes a plurality of write lines WSL extending in a row direction, and a plurality of signal lines DTL extending in a column direction. Each pixel 14 is provided in correspondence to an intersection of each signal line DTL and each write line WSL. Each signal line DTL is connected to an output end (not shown) of the data line drive circuit 15. Each write line WSL is connected to an output end (not shown) of the scan line drive circuit 16.

For example, the data line drive circuit 15 may receive analog image signals for one horizontal line from a drive circuit 20, and supplies the analog image signals, as signal voltages, to the individual pixels 14. Specifically, for example, the data line drive circuit 15 may supply the analog image signals for one horizontal line selected by the scan line drive circuit 16 to the pixels 14 configuring the one horizontal line through the signal lines DTL.

For example, the scan line drive circuit 16 may have a function of selecting pixels 14 to be driven in response to a scan timing control signal supplied from the drive circuit 20. Specifically, for example, the scan line drive circuit 16 may apply a selection pulse to a selection circuit (not shown) in the pixel 14 through the scan line WSL, and thereby selects one row of pixels 14, as the pixels 14 to be driven, among the pixels 14 formed in a matrix. Such pixels 14 perform display corresponding to one horizontal line based on the signal voltages supplied from the data line drive circuit 15. In this way, for example, the scan line drive circuit 16 may time-divisionally perform sequential scan by one horizontal line basis for display over the entire pixel region.

### (Drive Circuit 20)

For example, as illustrated in FIG. 1, the drive circuit 20 may include a single driver IC 30, and may include a set of a VCOM circuit 40 and a precharge circuit 50 for each of the liquid crystal display panels 10R, 10G, and 10B. The driver IC 30 corresponds to a specific but not limitative example of “driver IC” of one embodiment of the present technology. The VCOM circuit 40 and the precharge circuit 50 correspond to a specific but not limitative example of “individual circuit that applies a predetermined voltage to a light modulation element” of one embodiment of the present technology.

### (VCOM Circuit 40 and Precharge Circuit 50)

The VCOM circuit 40 generates a predetermined common voltage Vcom (predetermined voltage) using a reference voltage Vref applied from a reference voltage generation circuit 35 described later, and applies the common voltage Vcom to the liquid crystal display panel 10. The precharge circuit 50 generates a precharge signal (predetermined voltage) for precharge of the liquid crystal display panel 10 using the reference voltage Vref applied from the reference voltage generation circuit 35 described later, and applies the precharge signal to the liquid crystal display panel 10.

### (Driver IC 30)

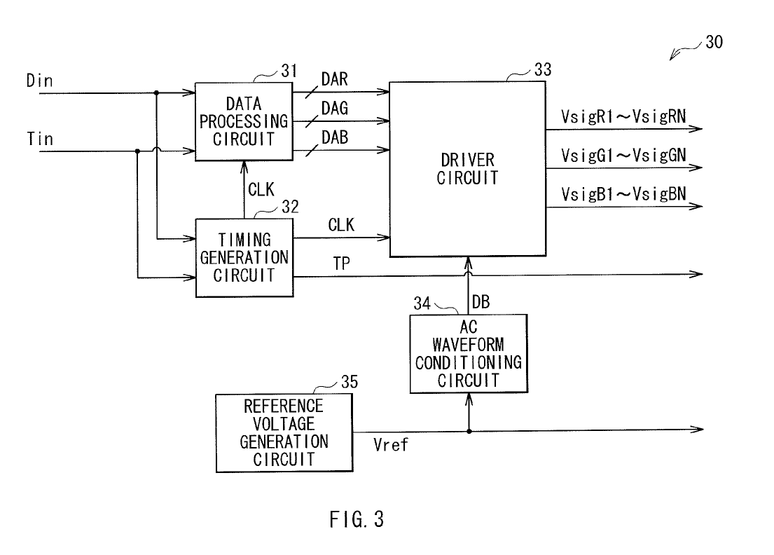

FIG. 3 illustrates an exemplary internal configuration of the driver IC 30. The driver IC 30 drives a plurality of light modulation elements that each perform light modulation on received light in response to applied voltage. For example, the driver IC 30 may include a data processing circuit 31, a timing generation circuit 32, a driver circuit 33, an AC waveform conditioning circuit 34, and a reference voltage generation circuit 35. The AC waveform conditioning circuit 34 corresponds to a specific but not limitative example of “conditioning circuit” of one embodiment of the present technology. The reference voltage Vref corresponds to a specific but not limitative example of “second reference voltage” of one embodiment of the present technology.

### (Data Processing Circuit 31)

The data processing circuit 31 generates, from an image signal Din, an image signal DAR′ (not shown) for a liquid crystal display panel 10R, an image signal DAG′ (not shown) for a liquid crystal display panel 10G, and an image signal DAB′ (not shown) for a liquid crystal display panel 10B. In addition, the data processing circuit 31 performs predetermined correction on each of the image signals DAR′, DAG′, and DAB′, and outputs, to the driver circuit 33, the corrected image signals as image signals DAR, DAG, and DAB. Examples of the predetermined correction may include γ correction and white balance correction. The γ correction refers to correction of grayscale of an image to be fit to an optimum curve corresponding to a gamma value. The white balance correction refers to correction of a white color to be shown as accurate white under any of light sources having various color temperatures.

Furthermore, the data processing circuit 31 performs parallelization processing on a serial digital image signal Din to be evolved into a plurality of parallel image signals. The data processing circuit 31 outputs the phase-evolved image signals to the driver circuit 33 at certain timing based on a clock CLK from the timing generation circuit 32. Hence, the image signals DAR, DAG, and DAB are phase-evolved image signals. The data processing circuit 31 outputs the image signals DAR, DAG, and DAB to the driver circuit 33 at certain timing based on a horizontal synchronizing signal and a vertical synchronizing signal contained in a control signal Tin.

### (Timing Generation Circuit 32)

The timing generation circuit 32 generates a timing pulse TP, which is used to drive the liquid crystal display panel 10 and control horizontal and vertical write transfer, based on the horizontal synchronizing signal and the vertical synchronizing signal contained in the control signal Tin. The timing generation circuit 32 outputs the generated timing pulse TP at a predetermined timing to the liquid crystal display panel 10. For example, the timing generation circuit 32 may generate, as the timing pulse TP, a horizontal start pulse that instructs start of horizontal scan, a horizontal clock as a reference for horizontal scan, a vertical start pulse that instructs start of vertical scan, and a vertical clock as a reference for vertical scan. Furthermore, the timing generation circuit 32 generates a clock CLK for the data processing circuit 31, and outputs the clock CLK to the data processing circuit 31.

### (Driver Circuit 33)

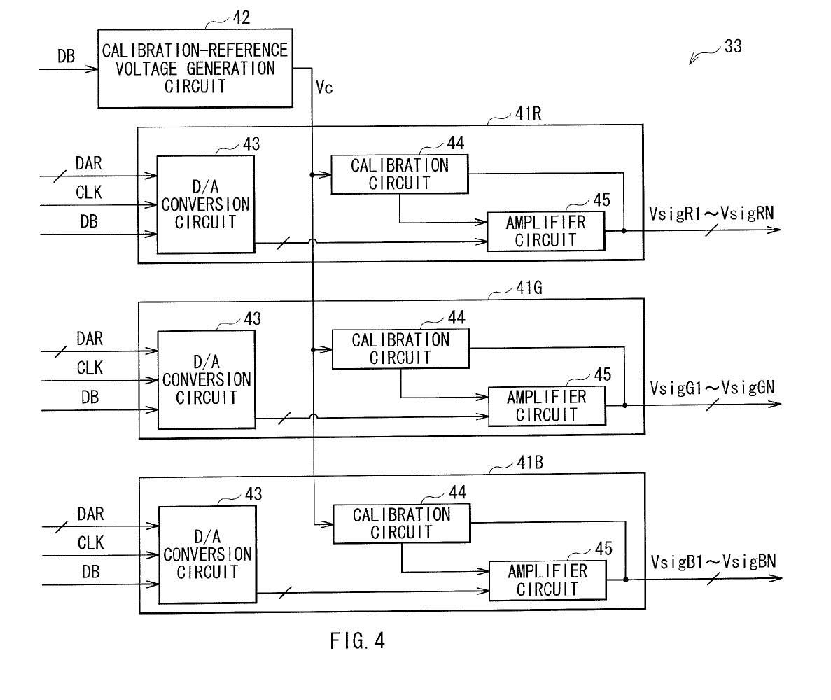

FIG. 4 illustrates an exemplary internal configuration of the driver circuit 33. The driver circuit 33 drives the liquid crystal display panel 10. The driver circuit 33 has liquid crystal drivers 41R, 41G, and 41B that are individually provided for the respective liquid crystal display panels 10R, 10G, and 10B. The liquid crystal driver 41R drives the liquid crystal display panel 10R. The liquid crystal driver 41G drives the liquid crystal display panel 10G. The liquid crystal driver 41B drives the liquid crystal display panel 10B. Hereinafter, a term “liquid crystal driver 41” is used as a general term of the liquid crystal drivers 41R, 41G, and 41B.

### (Calibration-Reference Voltage Generation Circuit 42)

The driver circuit 33 further includes a calibration-reference voltage generation circuit 42 (hereinafter, simply referred to as “Vc generation circuit 42”). The Vc generation circuit 42 is a circuit that generates a reference voltage Vc common to the liquid crystal drivers 41R, 41G, and 41B as a reference voltage, and supplies the reference voltage Vc to each of the liquid crystal drivers 41R, 41G, and 41B. The Vc generation circuit 42 corresponds to a specific but not limitative example of “generation circuit” or “first generation circuit” of one embodiment of the present technology.

### (Liquid Crystal Driver 41)

For example, the liquid crystal driver 41 may include a D/A conversion circuit 43, a calibration circuit 44, and an amplifier circuit 45. The calibration circuit 44 corresponds to a specific but not limitative example of “calibration circuit” of one embodiment of the present technology. The amplifier circuit 45 corresponds to a specific but not limitative example of “amplifier circuit” of one embodiment of the present technology. The D/A conversion circuit 43 converts the image signals DAR, DAG, and DAB (phase-evolved image signals) received from the data processing circuit 31 into analog signals, and outputs the analog signals to the amplifier circuit 45. The amplifier circuit 45 performs AC inversion on the analog image signals at a predetermined timing based on the clock CLK output from the timing generation circuit 50, and applies the AC-inverted analog image signals, as image signals Vsig1 to VsigN, to the liquid crystal display panel 10. The calibration circuit 44 uses the reference voltage Vc supplied from the Vc generation circuit 42 to reduce output deviation in an output channel of each amplifier circuit 45.

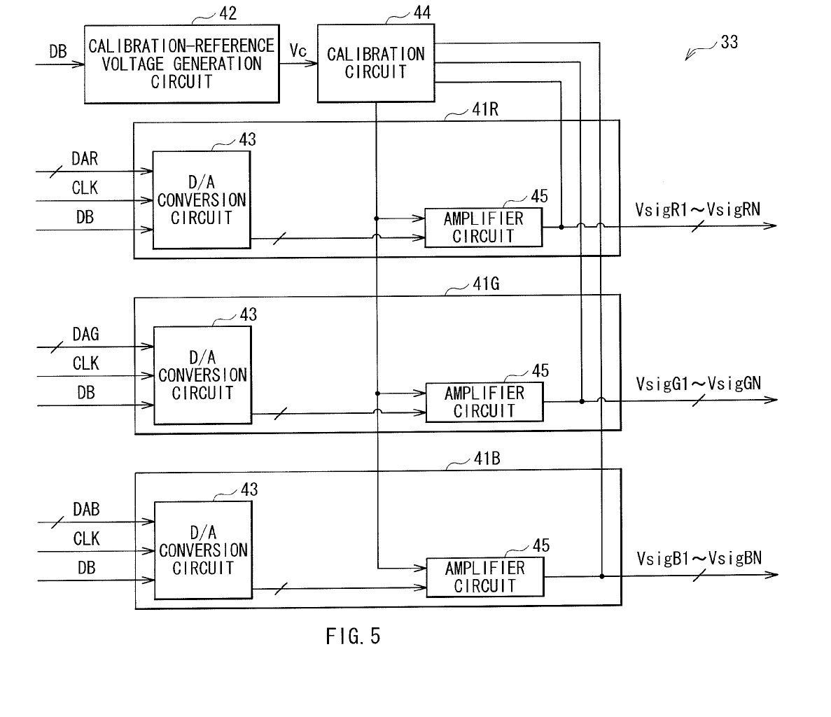

The calibration circuit 44 may not be individually provided in each liquid crystal driver 41. For example, as illustrated in FIG. 5, the calibration circuit 44 may be provided outside the liquid crystal drivers 41 as a circuit common to all the liquid crystal drivers 41. In such a case, the driver circuit 33 includes the liquid crystal drivers 41R, 41G, and 41B, the Vc generation circuit 42, and the calibration circuit 44. In the case where the calibration circuit 44 is a circuit common to all the liquid crystal drivers 41 as described above, it is preferred that the amplifier circuits 45 in the individual liquid crystal drivers 41 be sequentially controlled on a time-series basis. It is to be noted that the calibration circuit 44 may simultaneously control all the amplifier circuits 45, in the case where output deviation is the same between all the output channels of the individual amplifier circuits 45.

Description is now made on appearance of the driver IC 30 and a layout of wirings that connect the driver IC 30 to other circuits.

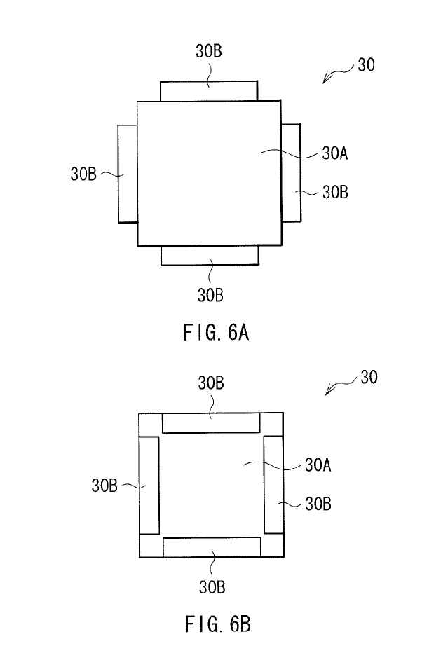

FIGS. 6A and 6B each illustrate an example of appearance of the driver IC 30. For example, as illustrated in FIGS. 6A and 6B, the driver IC 30 may include a chip body 30A defining a chip shape, and a plurality of terminals 30B. The terminal 30B corresponds to a specific but not limitative example of “output terminal” of one embodiment of the present technology. The chip body 30A may be configured of, for example, a resin-sealed chip in which the data processing circuit 31, the timing generation circuit 32, the driver circuit 33, the AC waveform conditioning circuit 34, and the reference voltage generation circuit 35 are integrated. The AC waveform conditioning circuit 34 corresponds to a specific but not limitative example of “conditioning circuit” of one embodiment of the present technology. The reference voltage generation circuit 35 corresponds to a specific but not limitative example of “second generation circuit” of one embodiment of the present technology.

For example, the chip body 30A may be a thin block having a square top and a square bottom. The plurality of terminals 30B are disposed on sides of the chip body 30A in such a manner that the respective terminals 30B are disposed on the different sides for the respective corresponding liquid crystal drivers 41. For example, as illustrated in FIG. 6A, the plurality of terminals 30B may each protrude from a side face of the chip body 30A while having a portion uncovered with the chip body 30A. In this configuration, each terminal 30B may be configured of, for example, a plurality of metal bars. For example, as illustrated in FIG. 6B, each of the terminals 30B may protrude from the bottom of the chip body 30A while having a portion uncovered with the chip body 30A. In such a case, for example, each terminal 30B may be configured of a plurality of metal pads.

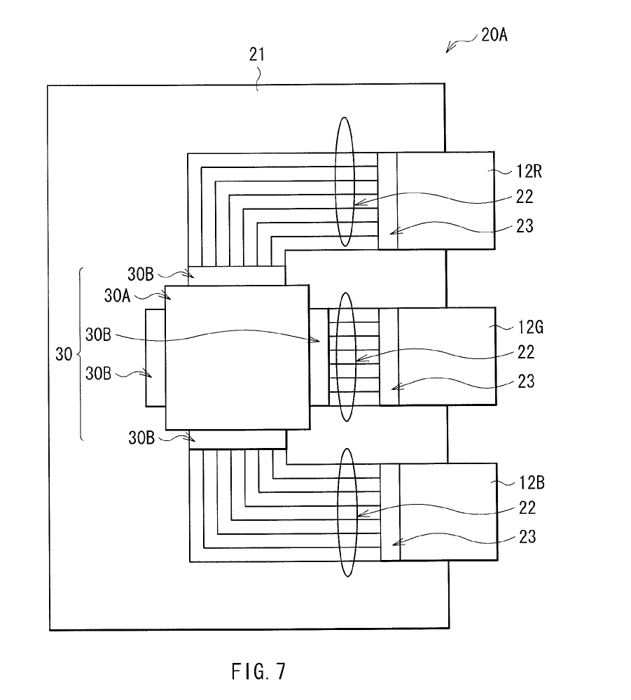

FIG. 7 illustrates an exemplary layout of wirings that connect the driver IC 30 to other circuits. For example, as illustrated in FIG. 7, the drive circuit 20 may include a mounting board 20A including a wiring substrate 21 on which one driver IC 30 is mounted. The wiring substrate 21 corresponds to a specific but not limitative example of “wiring substrate” of one embodiment of the present technology. The mounting board 20A corresponds to a specific but not limitative example of “mounting board” of one embodiment of the present technology. The wiring substrate 21 has electrode pads (not shown) configuring a mounting surface for the driver IC 30, a plurality of connection terminals 23 to be connected to respective one ends of FPCs 12R, 12G, and 12B, and a plurality of wirings 22 that connect the connection terminals 23 to the terminals 30B (specifically, the above-described electrode pads) of the driver IC 30. The wirings 22 correspond to a specific but not limitative example of “first wirings” of one embodiment of the present technology. The FPC 12R corresponds to FPC 12 for the liquid crystal display panel 10R. The FPC 12G corresponds to FPC 12 for the liquid crystal display panel 10G. The FPC 12B corresponds to FPC 12 for the liquid crystal display panel 10B.

The plurality of terminals 30B are separately disposed on different sides for the respective corresponding liquid crystal drivers 41. For example, as illustrated in FIG. 7, the terminals 30B may be individually disposed on the respective sides. In this configuration, in the case where the plurality of connection terminals 23 on the wiring substrate 21 are arranged in a line, the plurality of wirings 22 on the wiring substrate 21 are in a pectinate layout with their tips directed to the connection terminals 23. The plurality of wirings 22 are disposed in one layer on the wiring substrate 21 so as not to intersect with one another on the wiring substrate 21.

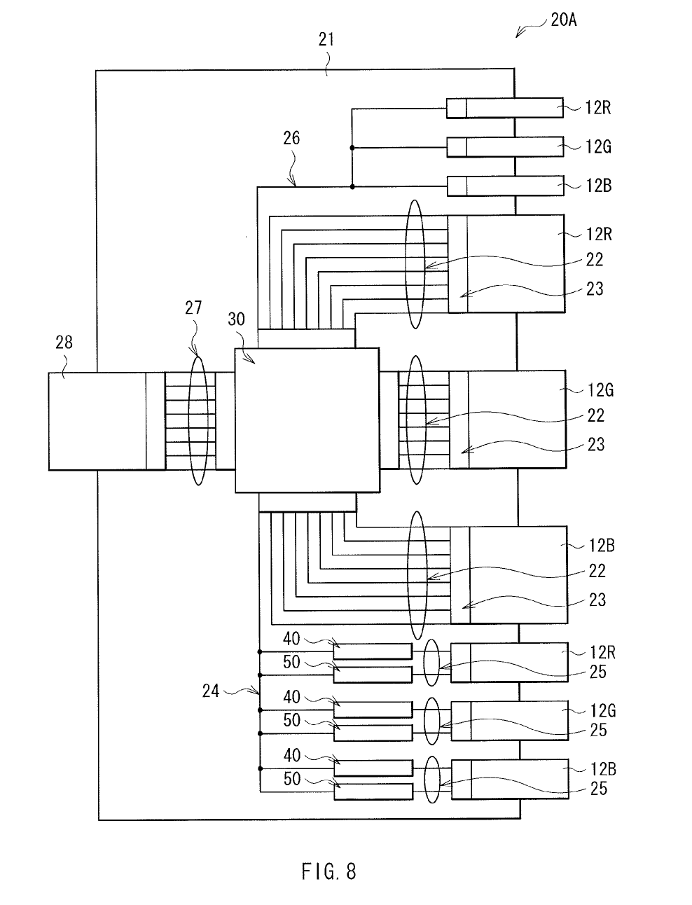

FIG. 8 illustrates an exemplary wiring layout which is based on the layout shown in FIG. 7, but is further provided with other circuits (the VCOM circuit 40 and the precharge circuit 50) mounted on the wiring substrate 21. For example, as illustrated in FIG. 8, the drive circuit 20 may include the mounting board 20A including the wiring substrate 21 on which one driver IC 30, the VCOM circuits 40, and the precharge circuits 50 are mounted. The wiring substrate 21 includes electrode pads (not shown) configuring a mounting surface for the driver IC 30, electrode pads (not shown) configuring a mounting surface for the VCOM circuits 40 and the precharge circuits 50, and a plurality of connection terminals 23. Moreover, the wiring substrate 21 includes a plurality of wirings 22, a plurality of wirings 24 that connect terminals 30B of the driver IC 30 to the VCOM circuits 40 and the precharge circuits 50, and a plurality of wirings 25 that connect the connection terminals 23 to the VCOM circuits 40 and the precharge circuits 50. The wiring 24 corresponds to a specific but not limitative example of “second wiring” of one embodiment of the present technology. The wiring 25 corresponds to a specific but not limitative example of “third wiring” of one embodiment of the present technology.

Moreover, the wiring substrate 21 includes a plurality of wirings 26 that connect the plurality of connection terminals 23 to a certain terminal outputting the timing pulse TP among the terminals 30B of the driver IC 30. Furthermore, the wiring substrate 21 includes a plurality of wirings 27 that connect the plurality of connection terminals 23 to certain terminals outputting the image signal Din and the control signal Tin among the terminals 30B of the driver IC 30.

The plurality of terminals 30B are separately disposed on different sides for the respective corresponding liquid crystal drivers 41. For example, as illustrated in FIG. 8, the terminals 30B may be individually disposed on the respective sides. In this configuration, in the case where the plurality of connection terminals 23 (other than the connection terminal 23 to which the wirings 27 are connected) on the wiring substrate 21 are arranged in a line, the plurality of wirings 22, 24, 25, and 26 on the wiring substrate 21 are in a pectinate layout with their tips directed to the connection terminals 23. The plurality of wirings 22, 24, 25, and 26 are disposed in one layer on the wiring substrate 21 so as not to intersect with one another on the wiring substrate 21.

The AC waveform conditioning circuit 34 and the reference voltage generation circuit 35 are now described.

### (AC Waveform Conditioning Circuit 34)

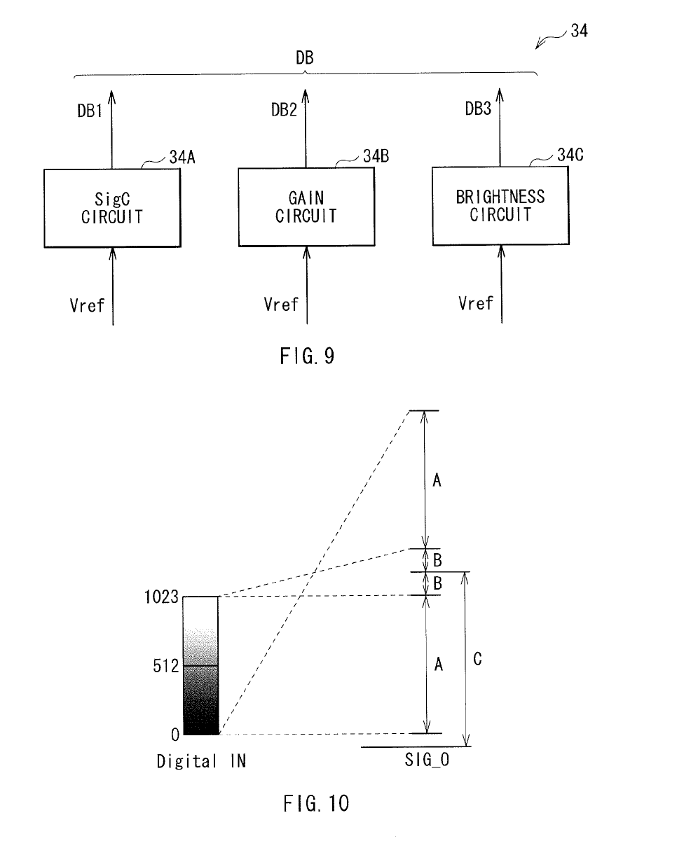

The AC waveform conditioning circuit 34 performs waveform conditioning on output signals from each of the liquid crystal drivers 41R, 41G, and 41B in the driver circuit 33. The AC waveform conditioning circuit 34 is used in common by the liquid crystal drivers 41R, 41G, and 41B. For example, as illustrated in FIG. 9, the AC waveform conditioning circuit 34 may include a SigC circuit 34A, a gain circuit 34B, and a brightness circuit 34C. For example, the SigC circuit 34A may determine a center value of an AC analog signal generated through conversion from a digital signal to an analog signal. For example, the gain circuit 34B may determine a correspondence relationship between grayscale of the digital signal and an amplitude value of the analog signal. For example, the brightness circuit 34C may determine a correspondence relationship between maximum grayscale of the digital signal and a minimum amplitude value of the analog signal.

### (Reference Voltage Generation Circuit 35)

The reference voltage generation circuit 35 generates the reference voltage Vref common to the VCOM circuit 40, the precharge circuit 50, and the AC waveform conditioning circuit 34, and applies the reference voltage Vref to such circuits. The reference voltage generation circuit 35 is a circuit used in common by the liquid crystal drivers 41R, 41G, and 41B as with the AC waveform conditioning circuit 34.

### [Effects]

Effects of the display unit 1 are now described. In the display unit 1, the single driver IC 30 incorporates the liquid crystal drivers 41 that are individually provided for the respective liquid crystal display panels 10R, 10G, and 10B. This reduces areal occupancy of the driver IC 30 in the surface of the wiring substrate 21 compared with a case where the driver ICs 30 are individually provided for the respective liquid crystal display panels 10R, 10G, and 10B. In the case where the driver ICs 30 are individually provided for the respective liquid crystal display panels 10R, 10G, and 10B, a large number of wirings are provided on the wiring substrate 21, the wirings connecting each driver IC 30 to various circuits that, for example, adjust output from the driver IC 30 (for example, the VCOM circuit 40 and the precharge circuit 50). In such a case, if all of such wirings are provided in one layer on the wiring substrate 21, a wiring layout becomes extremely complicated, and areal occupancy of the wirings increases in the surface of the wiring substrate 21. In contrast, in the first embodiment, since the plurality of liquid crystal drivers 41 are incorporated in the single driver IC 30, the above-described various circuits are easily incorporated in the driver IC 30. Furthermore, in the first embodiment, the plurality of output terminals 30B are separately disposed on different sides for the respective corresponding liquid crystal drivers 41. This extremely simplifies the wiring layout around the driver IC 30, and reduces areal occupancy of the wirings in the surface of the wiring substrate 21. Consequently, the wiring layout around the driver IC 30 is simplified, and areal occupancy of wirings is reduced in the surface of the wiring substrate 21.

In addition, in the first embodiment, each of the AC waveform conditioning circuit 34 and the reference voltage generation circuit 35 is used in common by the liquid crystal drivers 41R, 41G, and 41B. This reduces areal occupancy of such circuits in the surface of the wiring substrate 21 compared with a case where such circuits are provided for each of the liquid crystal drivers 41R, 41G, and 41B.

Moreover, in the first embodiment, the VCOM circuit 40 and the precharge circuit 50 are provided for each of the liquid crystal display panels 10R, 10G, and 10B. As a result, even if the optimum common voltage Vcom and/or pixel holding potential, which are each based on leakage characteristics of the pixel transistors of the respective liquid crystal display panels 10R, 10G, and 10B, are varied between the liquid crystal display panels 10R, 10G, and 10B, such variations are minimized in the individual liquid crystal display panels 10R, 10G, and 10B.

### 2. Modifications of First Embodiment

### [Modification 1]

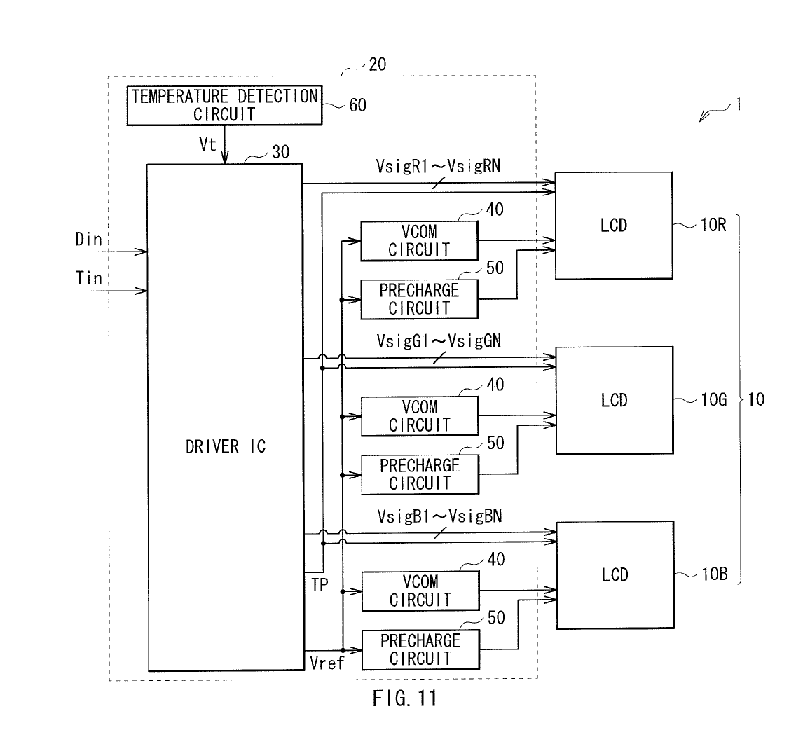

FIG. 11 illustrates a configuration of a display unit 1 corresponding to Modification 1 of the first embodiment. The display unit 1 according to the Modification 1 is configured by modifying the display unit 1 of the first embodiment such that the display unit 1 further includes a temperature detection circuit 60 that detects temperature of the mounting board 20A. The temperature detection circuit 60 corresponds to a specific but not limitative example of “first detection circuit” of one embodiment of the present technology.

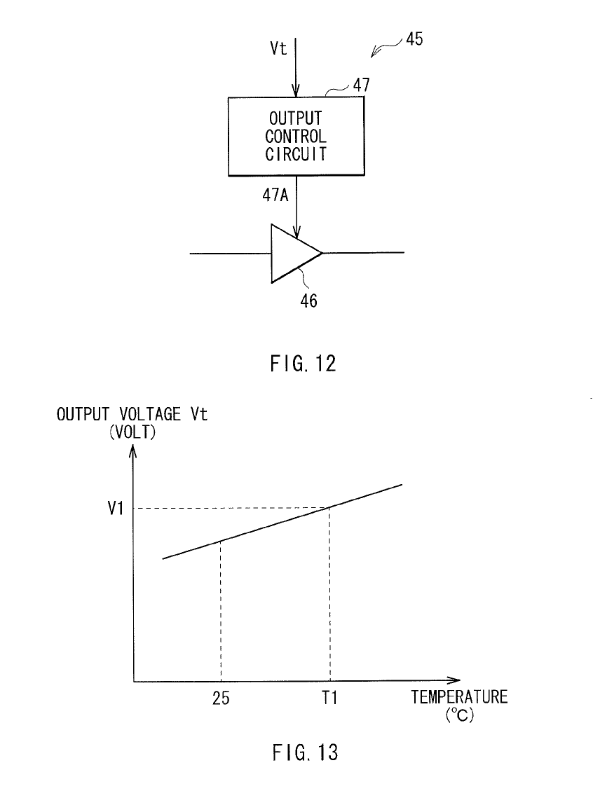

In the Modification 1, the mounting board 20A further includes the temperature detection circuit 60 on the wiring substrate 21. In such a configuration, for example, as illustrated in FIG. 12, the amplifier circuit 45 may be configured of a video signal amplifier 46 that drives the liquid crystal display panel 10, and an output control circuit 47 that outputs a control signal 47A, which reduces or stops output from the amplifier circuit 45, to the amplifier circuit 45 in response to output from the temperature detection circuit 60.

For example, as illustrated in FIG. 13, the temperature detection circuit 60 may output a higher voltage as output voltage Vt in proportion to an increase in temperature of the mounting board 20A. At this time, when the output control circuit 47 detects a voltage V1 corresponding to a predetermined temperature T1 (for example, 125° C.) as the output voltage Vt, the output control circuit 47 outputs the control signal 47A, which reduces or stops output from the amplifier circuit 45, to the amplifier circuit 45. As a result, if the driver IC 30 (mounting board 20A) is nearly overheated, output from the amplifier circuit 45 is reduced or stopped, thereby making it possible to prevent breakage of the driver IC 30 (mounting board 20A) due to heating thereof.

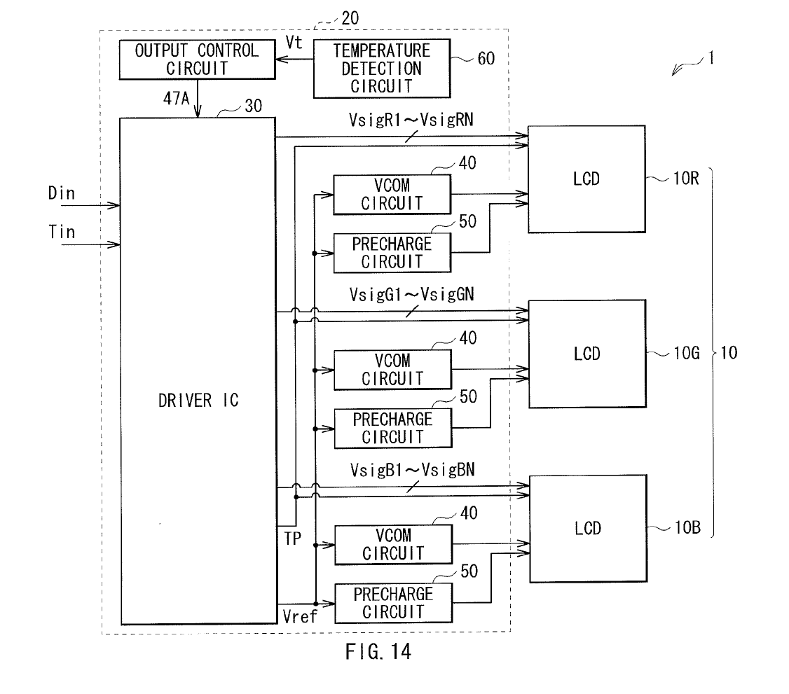

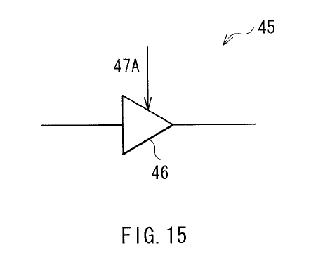

In the Modification 1, for example, as illustrated in FIG. 14, the output control circuit 47 may be provided separately from the driver IC 30. In such a case, for example, as illustrated in FIG. 15, the amplifier circuit 45 may be configured of only the video signal amplifier 46 without the output control circuit 47. Hence, in this case, the driver IC 30 receives output (the control signal 47A) from the output control circuit 47.

### [Modification 2]

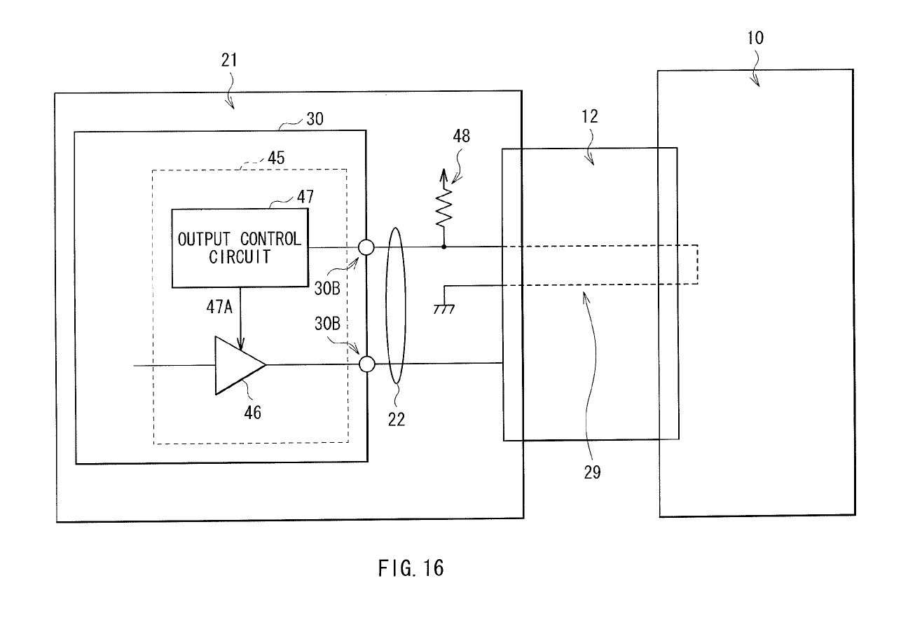

FIG. 16 illustrates a configuration of a display unit 1 corresponding to Modification 2 of the first embodiment. The display unit 1 according to the Modification 2 is configured by modifying the display unit 1 of the first embodiment such that the display unit 1 further includes a detection mechanism that detects presence of electrical connection between the driver IC 30 and the liquid crystal display panel 10. For example, as illustrated in FIG. 16, such a detection mechanism may include an output control circuit 47, a wiring 29 connected to an input terminal (not shown) of the output control circuit 47, and a pull-up circuit 48 connected to the wiring 29 at a point close to the output control circuit 47.

The wiring 29 extends from the input terminal of the output control circuit 47 to the liquid crystal display panel 10 through the FPC 12, and returns from the liquid crystal display panel 10 to the wiring substrate 21 through the FPC 12. The wiring 29 is connected to a ground potential line (reference potential line) of the wiring substrate 21 at an end (or a point near the end) of the wiring 29 on a side opposite to a side close to the input terminal of the output control circuit 47.

In the Modification 2, the output control circuit 47 detects a voltage of the wiring 29. For example, when the output control circuit 47 detects that a voltage of the wiring 29 is higher than a predetermined threshold voltage (for example, equal to a voltage determined by the pull-up circuit 48), the output control circuit 47 may output a control signal 47A, which reduces or stops output from the amplifier circuit 45, to the amplifier circuit 45. Also, for example, when the output control circuit 47 detects that a voltage of the wiring 29 is lower than the predetermined threshold voltage (for example, equal to the ground potential line (reference potential line)), the output control circuit 47 may not limit the output from the amplifier circuit 45. It is to be noted that the case where the voltage of the wiring 29 is higher than the predetermined threshold voltage (for example, equal to the voltage determined by the pull-up circuit 48) corresponds to the case where the wiring 29 is not connected to the ground potential line (reference potential line), i.e., the circuit is open.

In the Modification 2, a pull-down circuit (not shown) may be connected to the wiring 29 in place of the pull-up circuit 48. In such a case, the wiring 29 is connected to a high-voltage line of the wiring substrate 21 at an end (or a point near the end) of the wiring 29 on a side opposite to a side close to the input terminal of the output control circuit 47. For example, when the output control circuit 47 detects that a voltage of the wiring 29 is lower than a predetermined threshold voltage (for example, equal to a voltage determined by the pull-down circuit), the output control circuit 47 may output a control signal 47A, which reduces or stops output from the amplifier circuit 45, to the amplifier circuit 45. Also, for example, when the output control circuit 47 detects that a voltage of the wiring 29 is higher than a predetermined threshold voltage (for example, equal to a voltage of the high-voltage line), the output control circuit 47 may not limit the output from the amplifier circuit 45.

In the Modification 2, the display unit 1 includes the detection mechanism that detects presence of electrical connection between the driver IC 30 and the liquid crystal display panel 10. Consequently, when the output end of the driver IC 30 (amplifier circuit 45) is open, capability of the amplifier circuit 45 is reduced to increase a phase margin of the output signal from the amplifier circuit 45. As a result, oscillation of the amplifier circuit 45 is prevented.

### [Modification 3]

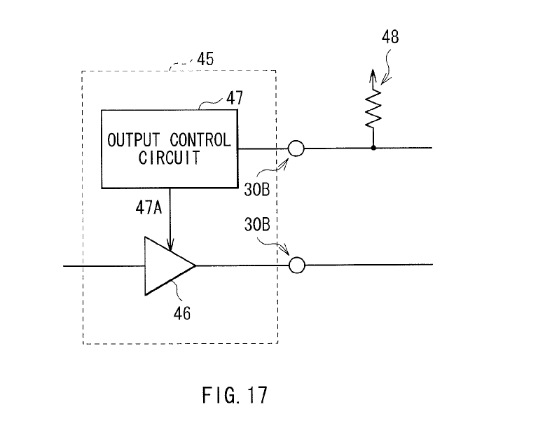

FIG. 17 illustrates a configuration of a display unit 1 corresponding to Modification 3 of the first embodiment. The display unit 1 according to the Modification 3 has the configuration of the Modification 1 together with the configuration of the Modification 2. Specifically, the display unit 1 according to the Modification 3 is configured by modifying the display unit 1 of the first embodiment such that the display unit 1 further includes the temperature detection circuit 60, the output control circuit 47, and the above-described detection mechanism that detects presence of electrical connection between the driver IC 30 and the liquid crystal display panel 10. This prevents breakdown of the driver IC 30 (mounting board 20A) due to heating thereof, and oscillation of the amplifier circuit 45.

### 3. Second Embodiment

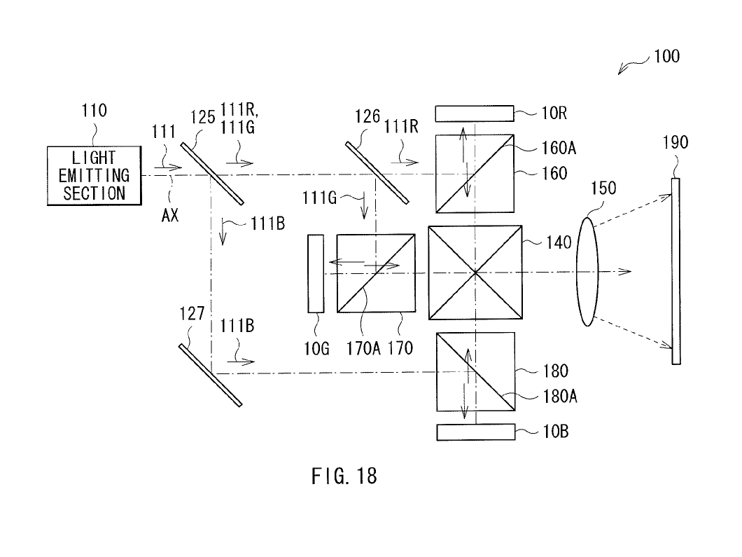

FIG. 18 illustrates an exemplary overall configuration of a projector 100 (projection display unit) according to a second embodiment of the present technology. For example, the projector 100 may project an image, which is being displayed on a screen of an undepicted information processing unit, onto a screen 190. The projector 100 is a reflective liquid crystal projector using a reflective liquid crystal panel as a light valve. The light valve corresponds to the display unit 1 according to any of the first embodiment and the Modifications thereof.

For example, the projector 100 may be a so-called three-plate-type projector that performs color image display using three light valves for colors of red, green, and blue. For example, the projector 100 may include a light emitting section 110, dichroic mirrors 125 and 126, a total reflection mirror 127, liquid crystal display panels 10R, 10G, and 10B, and a drive circuit 20. Furthermore, for example, the projector 100 may include polarization beam splitters 160, 170, and 180, a composite prism 140, and a projection lens 150. An optical system configured of the dichroic mirrors 125 and 126, the total reflection mirror 127, the polarization beam splitters 160, 170, and 180, and the composite prism 140 corresponds to a specific but not limitative example of “illumination optical system”. Moreover, the projection lens 150 corresponds to a specific but not limitative example of “projection optical system”.

The light emitting section 110 emits white light containing red light, blue light, and green light to be necessary for color image display, and may be configured of, for example, a halogen lamp, a metal halide lamp, a xenon lamp, or the like. The dichroic mirror 125 is disposed on an optical path AX of the light emitting section 110, and has a function of splitting light from the light emitting section 110 into blue light 111B and other colors of light (red light 111R and green light 111G). The dichroic mirror 126 is disposed on the optical path AX of the light emitting section 110, and has a function of splitting light passing through the dichroic mirror 125 into the red light 111R and the green light 111G. The total reflection mirror 127 is disposed on an optical path of light reflected by the dichroic mirror 125, and reflects the blue light 111B split by the dichroic mirror 125 toward the polarization beam splitter 180.

The polarization beam splitter 160 is disposed on an optical path of the red light 111R, and has a function of splitting the received red light 111R into two orthogonal polarization components by a polarization splitting surface 160A. The polarization beam splitter 170 is disposed on an optical path of the green light 111G, and has a function of splitting the received green light 111G into two orthogonal polarization components by a polarization splitting surface 170A. The polarization beam splitter 180 is disposed on an optical path of the blue light 111B, and has a function of splitting the received blue light 111B into two orthogonal polarization components by a polarization splitting surface 180A. Each of the polarization splitting surfaces 160A, 170A, and 180A reflects one polarization component (for example, s-polarized light component), but transmits the other polarization component (for example, p-polarized light component).

The light valve corresponds to the display unit 1 according to any of the first embodiment and the Modifications thereof, and generates image light of each color through modulation of received light based on received image signals. The red light valve (liquid crystal display panel 10R) is disposed on an optical path of the red light 111R reflected by the polarization splitting surface 160A. For example, the red light valve (liquid crystal display panel 10R) may be driven by a digital signal subjected to pulse width modulation (PWM) based on a red image signal, so that the red light valve modulates the received light, and reflects the modulated light toward the polarization beam splitter 160. The green light valve (liquid crystal display panel 10G) is disposed on an optical path of the green light 111G reflected by the polarization splitting surface 170A. For example, the green light valve (liquid crystal display panel 10G) may be driven by a digital signal subjected to pulse width modulation (PWM) based on a green image signal, so that the green light valve modulates the received light, and reflects the modulated light toward the polarization beam splitter 170. The blue light valve (liquid crystal display panel 10B) is disposed on an optical path of the blue light 111B reflected by the polarization splitting surface 180A. For example, the blue light valve (liquid crystal display panel 10B) may be driven by a digital signal subjected to pulse width modulation (PWM) based on a blue image signals, so that the blue light valve modulates the received light, and reflects the modulated light toward the polarization beam splitter 180.

The composite prism 140 is disposed at an intersection of the optical paths for the respective pieces of modulated light that are emitted from the light valves for the respective colors of light, and are transmitted by the polarization beam splitters 160, 170, and 180. The composite prism 140 has a function of composing the pieces of modulated light to generate color image light. The projection lens 150 is disposed on an optical path of the image light emitted from the composite prism 140, and has a function of projecting the image light emitted from the composite prism 140 onto the screen 190.

In the second embodiment, the display unit 1 according to any of the first embodiment and the Modifications thereof is used as the light valve for each color of light. This allows a compact light valve to be achieved, thereby making it possible to reduce size of the projector 100. In addition, this prevents troubles of the projector 100, such as failure due to heating or oscillation, associated with a reduction in size of the projector 100.

### 4. Third Embodiment

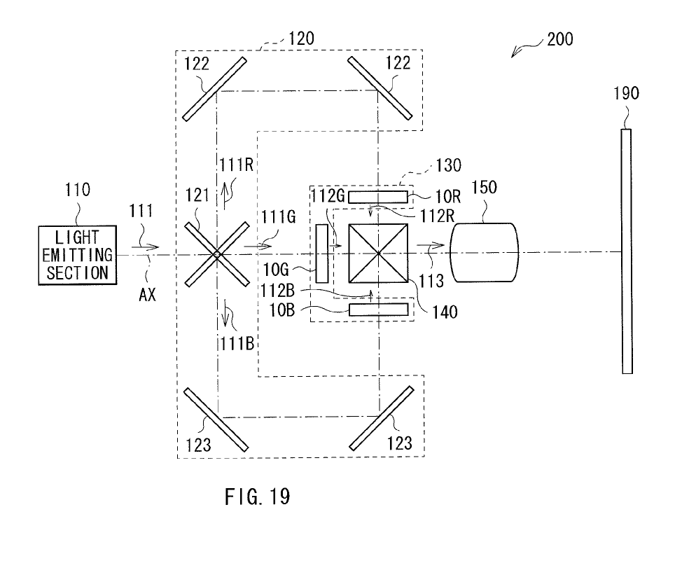

FIG. 19 illustrates an exemplary overall configuration of a projector 200 (projection display unit) according to a third embodiment of the present technology. For example, the projector 200 may project an image, which is being displayed on a screen of an undepicted information processing unit, onto a screen 190. The projector 200 is a transmissive liquid crystal projector using a transmissive liquid crystal panel as a light valve. The light valve corresponds to the display unit 1 according to any of the first embodiment and the Modifications thereof.

For example, the projector 200 may be a so-called three-plate-type projector that performs color image display using three liquid-crystal light valves (optical modules 17) for colors of red, green, and blue. For example, the projector 200 may include a light emitting section 110, an optical-path branching section 120, a spatial light modulation section 130, a composite prism 140, and a projection lens 150.

The optical-path branching section 120 splits light 111 output from the light emitting section 110 into a plurality of colors of light having different wavelength bands, and guides each color of light to a surface to be irradiated of the spatial light modulation section 130. For example, as illustrated in FIG. 19, the optical-path branching section 120 may be configured of one cross mirror 121 and four mirrors 122. The cross mirror 121 splits light 111 output from the light emitting section 110 into a plurality of colors of light having different wavelength bands while branching the optical path for each color of light. For example, the cross mirror 121 may be disposed on a light axis AX, and is configured of two mirrors that have different types of wavelength selectivity and are connected to each other in a crossed manner. The four mirrors 122 each reflect each of colors of light (the red light 111R and the blue light 111B in FIG. 19) branched in optical path by the cross mirror 121, and are each disposed at a position that is not on the light axis AX. Two out of the four mirrors 122 are disposed so as to guide light (the red light 111R in FIG. 19), which is reflected in one direction crossing the light axis AX by one mirror included in the cross mirror 121, to a surface to be irradiated of the liquid crystal display panel 10R. The other two of the four mirrors 122 are disposed so as to guide light (the blue light 111B in FIG. 19), which is reflected in the other direction crossing the light axis AX by the other mirror included in the cross mirror 121, to a surface to be irradiated of the liquid crystal display panel 10B. Part of the light 111 output from the light emitting section 110 (the green light 111G in FIG. 19) is transmitted by the cross mirror 121, passes along the light axis AX, and enters a surface to be irradiated of the liquid crystal display panel 10G disposed on the light axis AX.

The liquid crystal display panel 10R is disposed in a region opposed to a first surface of the composite prism 140. The liquid crystal display panel 10R modulates the received red light 111R based on image signals to generate red image light 112R, and outputs the red image light 112R to the first surface of the composite prism 140 at the back of the liquid crystal display panel 10R. The liquid crystal display panel 10G is disposed in a region opposed to a second surface of the composite prism 140. The liquid crystal display panel 10G modulates the received green light 111G based on image signals to generate green image light 112G, and outputs the green image light 112G to the second surface of the composite prism 140 at the back of the liquid crystal display panel 10G. The liquid crystal display panel 10B is disposed in a region opposed to a third surface of the composite prism 140. The liquid crystal display panel 10B modulates the received blue light 111B based on image signals to generate blue image light 112B, and outputs the blue image light 112B to the third surface of the composite prism 140 at the back of the liquid crystal display panel 10B.

The composite prism 140 composes a plurality of pieces of modulated light to generate image light. For example, the composite prism 140 may be disposed on the light axis AX, and may be, for example, a cross prism configured of four prisms bonded to one another. Each of the bonded surfaces of the prisms has either of two selective reflection surfaces having different types of wavelength selectivity, each selective reflection surface being configured of, for example, a multilayer interference film. For example, one selective reflection surface may reflect the red image light 112R output from the liquid crystal display panel 10R in a direction parallel to the light axis AX, and guides the reflected light toward the projection lens 150. For example, the other selective reflection surface may reflect the blue image light 112B output from the liquid crystal display panel 10B in the direction parallel to the light axis AX, and guides the reflected light toward the projection lens 150. The green image light 112G output from the liquid crystal display panel 10G is transmitted by the two selective reflection surfaces, and then advances toward the projection lens 150. Eventually, the composite prism 140 composes the pieces of image light generated by the liquid crystal display panels 10R, 10G, and 10B to generate image light 113, and outputs the generated image light 113 to the projection lens 150.

The projection lens 150 projects the image light 113 output from the composite prism 140 onto the screen 190 for image display. For example, the projection lens 150 may be disposed on the light axis AX.

In the third embodiment, the display unit 1 according to any of the first embodiment and the Modifications thereof is used as the light valve for each color of light. This allows a compact light valve to be achieved, thereby making it possible to reduce size of the projector 200. In addition, this prevents troubles of the projector 200, such as failure due to heating or oscillation, associated with a reduction in size of the projector 200.

Furthermore, the technology encompasses any possible combination of some or all of the various embodiments described herein and incorporated herein.

It is possible to achieve at least the following configurations from the above-described example embodiments of the disclosure.

(1) A driver IC, including:

a plurality of driver circuits that are individually provided for respective light modulation elements and drive the light modulation elements, the light modulation elements each performing light modulation on received light in response to an applied voltage; and

a plurality of output terminals outputting signals derived from the respective driver circuits to outside,

wherein the driver IC is a single driver IC that drives the light modulation elements, and

the output terminals are disposed on sides of the driver IC, and the respective output terminals are disposed on the different sides for the respective corresponding driver circuits.

(2) The driver IC according to (1), further including a generation circuit,

wherein each of the driver circuits includes an amplifier circuit and a calibration circuit, the amplifier circuit driving corresponding one of the light modulation elements, and the calibration circuit reducing, based on a reference voltage, output deviation in an output channel of the corresponding amplifier circuit, and

the generation circuit generates a voltage common to the driver circuits as the reference voltage, and supplies the voltage to each of the driver circuits.

(3) The driver IC according to (1), further including:

a calibration circuit; and

a generation circuit,

wherein each of the driver circuits includes an amplifier circuit that drives corresponding one of the light modulation elements,

the calibration circuit reduces, based on a reference voltage, output deviation in an output channel of each of the amplifier circuits, and

the generation circuit generates the reference voltage, and supplies the reference voltage to the calibration circuit.

(4) A mounting board, including

a single driver IC mounted on a wiring substrate, the driver IC driving a plurality of light modulation elements, and the light modulation elements each performing light modulation on received light in response to an applied voltage,

the driver IC including
a plurality of driver circuits that are individually provided for the respective light modulation elements and drive the light modulation elements, and
a plurality of output terminals outputting signals derived from the respective driver circuits to outside, the output terminals being disposed on sides of the driver IC, and the respective output terminals being disposed on the different sides for the respective corresponding driver circuits.
   (5) The mounting board according to (4), wherein

each of the driver circuits includes an amplifier circuit and a calibration circuit, the amplifier circuit driving corresponding one of the light modulation elements, and the calibration circuit reducing, based on a first reference voltage, output deviation in an output channel of the corresponding amplifier circuit, and

the driver IC includes a generation circuit, the generation circuit generating a voltage common to the driver circuits as the first reference voltage, and supplying the voltage to each of the driver circuits.

(6) The mounting board according to (4), wherein

each of the driver circuits includes an amplifier circuit that drives corresponding one of the light modulation elements, and

the driver IC includes a calibration circuit and a first generation circuit, the calibration circuit reducing, based on a first reference voltage, output deviation in an output channel of each of the amplifier circuits, and the first generation circuit generating the first reference voltage, and supplying the first reference voltage to the calibration circuit.

(7) The mounting board according to any one of (4) to (6), wherein

the wiring substrate includes a plurality of first wirings that connect the driver IC to the light modulation elements, and

the first wirings are disposed in one layer without crossing one another.

(8) The mounting board according to any one of (4) to (7), further including a plurality of individual circuits that are individually provided on the wiring substrate for the respective light modulation elements, and each apply a predetermined voltage to corresponding one of the light modulation elements,

wherein the driver IC includes a conditioning circuit and a second generation circuit, the conditioning circuit performing waveform conditioning on the output signal of each of the driver circuits, and the second generation circuit generating a second reference voltage that is common to the conditioning circuit and the individual circuits, and applying the second reference voltage to the conditioning circuit and the individual circuits.

(9) The mounting board according to (7), further including a plurality of individual circuits that are individually provided on the wiring substrate for the respective light modulation elements, and each apply a predetermined voltage to corresponding one of the light modulation elements,

wherein the driver IC includes a conditioning circuit and a second generation circuit, the conditioning circuit performing waveform conditioning on the output signal of each of the driver circuits, and the second generation circuit generating a second reference voltage that is common to the conditioning circuit and the individual circuits, and applying the second reference voltage to the conditioning circuit and the individual circuits,

the wiring substrate includes second wirings and third wirings, the second wirings connecting the driver IC to the individual circuits, and the third wirings connecting the individual circuits to the respective light modulation elements, and

the first wirings, the second wirings, and the third wirings are disposed in one layer without crossing one another.

(10) The mounting board according to any one of (4) to (9), further including a first detection circuit provided on the wiring substrate and detecting a temperature of the mounting board,

wherein any of the driver circuits reduces or stops, based on an output of the first detection circuit, an output of the driver circuit.

(11) The mounting board according to any one of (4) to (10), further including a second detection circuit provided on the wiring substrate and detecting a presence of electrical connection between the driver IC and each of the light modulation elements,

wherein any of the driver circuits reduces or stops, based on an output of the second detection circuit, an output of the driver circuit.

(12) A display unit, including:

a plurality of light modulation elements each performing light modulation on received light in response to an applied voltage; and

a mounting board including a single driver IC mounted on a circuit substrate, the driver IC driving the light modulation elements,

wherein the mounting board includes

a plurality of driver circuits that are individually provided for the respective light modulation elements, and drive the light modulation elements, and

a plurality of output terminals outputting signals derived from the respective driver circuits to outside, the output terminals being disposed on sides of the driver IC, and the respective output terminals being disposed on the different sides for the respective corresponding driver circuits.

(13) A projection display unit, including:

an illumination optical system;

a plurality of light modulation elements each generating image light through modulation of light derived from the illumination optical system in response to an applied voltage;

a mounting board including a single driver IC mounted on a circuit substrate, the driver IC driving the light modulation elements; and

a projection optical system projecting the image light generated by the light modulation elements,

wherein the mounting board includes

a plurality of driver circuits that are individually provided for the respective light modulation elements, and drive the light modulation elements, and

a plurality of output terminals outputting signals derived from the respective driver circuits to outside, the output terminals being disposed on sides of the driver IC, and the respective output terminals being disposed on the different sides for the respective corresponding driver circuits.

The present disclosure contains subject matter related to that disclosed in Japanese Priority Patent Application JP 2012-174256 filed in the Japan Patent Office on Aug. 6, 2012, the entire content of which is hereby incorporated by reference.

It should be understood by those skilled in the art that various modifications, combinations, sub-combinations, and alterations may occur depending on design requirements and other factors insofar as they are within the scope of the appended claims or the equivalents thereof.

What is claimed is:

1. A driver IC, comprising:
a plurality of driver circuits that are individually provided for respective light modulation elements and drive the light modulation elements, the light modulation elements each performing light modulation on received light in response to an applied voltage; and
a plurality of output terminals outputting signals derived from the respective driver circuits to outside,
wherein the driver IC is a single driver IC that drives the light modulation elements, and
the output terminals are disposed on sides of the driver IC, and the respective output terminals are disposed on the different sides for the respective corresponding driver circuits.

2. The driver IC according to claim 1, further comprising a generation circuit,
wherein each of the driver circuits includes an amplifier circuit and a calibration circuit, the amplifier circuit driving corresponding one of the light modulation elements, and the calibration circuit reducing, based on a reference voltage, output deviation in an output channel of the corresponding amplifier circuit, and
the generation circuit generates a voltage common to the driver circuits as the reference voltage, and supplies the voltage to each of the driver circuits.

3. The driver IC according to claim 1, further comprising:
a calibration circuit; and
a generation circuit,
wherein each of the driver circuits includes an amplifier circuit that drives corresponding one of the light modulation elements,
the calibration circuit reduces, based on a reference voltage, output deviation in an output channel of each of the amplifier circuits, and
the generation circuit generates the reference voltage, and supplies the reference voltage to the calibration circuit.

4. A mounting board, comprising
a single driver IC mounted on a wiring substrate, the driver IC driving a plurality of light modulation elements, and the light modulation elements each performing light modulation on received light in response to an applied voltage,
the driver IC including
a plurality of driver circuits that are individually provided for the respective light modulation elements and drive the light modulation elements, and
a plurality of output terminals outputting signals derived from the respective driver circuits to outside, the output terminals being disposed on sides of the driver IC, and the respective output terminals being disposed on the different sides for the respective corresponding driver circuits.

5. The mounting board according to claim 4, wherein
each of the driver circuits includes an amplifier circuit and a calibration circuit, the amplifier circuit driving corresponding one of the light modulation elements, and the calibration circuit reducing, based on a first reference voltage, output deviation in an output channel of the corresponding amplifier circuit, and
the driver IC includes a generation circuit, the generation circuit generating a voltage common to the driver circuits as the first reference voltage, and supplying the voltage to each of the driver circuits.

6. The mounting board according to claim 4, wherein
each of the driver circuits includes an amplifier circuit that drives corresponding one of the light modulation elements, and
the driver IC includes a calibration circuit and a first generation circuit, the calibration circuit reducing, based on a first reference voltage, output deviation in an output channel of each of the amplifier circuits, and the first generation circuit generating the first reference voltage, and supplying the first reference voltage to the calibration circuit.

7. The mounting board according to claim 4, wherein
the wiring substrate includes a plurality of first wirings that connect the driver IC to the light modulation elements, and
the first wirings are disposed in one layer without crossing one another.

8. The mounting board according to claim 4, further comprising a plurality of individual circuits that are individually provided on the wiring substrate for the respective light modulation elements, and each apply a predetermined voltage to corresponding one of the light modulation elements,
wherein the driver IC includes a conditioning circuit and a second generation circuit, the conditioning circuit performing waveform conditioning on the output signal of each of the driver circuits, and the second generation circuit generating a second reference voltage that is common to the conditioning circuit and the individual circuits, and applying the second reference voltage to the conditioning circuit and the individual circuits.

9. The mounting board according to claim 7, further comprising a plurality of individual circuits that are individually provided on the wiring substrate for the respective light modulation elements, and each apply a predetermined voltage to corresponding one of the light modulation elements,
wherein the driver IC includes a conditioning circuit and a second generation circuit, the conditioning circuit performing waveform conditioning on the output signal of each of the driver circuits, and the second generation circuit generating a second reference voltage that is common to the conditioning circuit and the individual circuits, and applying the second reference voltage to the conditioning circuit and the individual circuits,
the wiring substrate includes second wirings and third wirings, the second wirings connecting the driver IC to the individual circuits, and the third wirings connecting the individual circuits to the respective light modulation elements, and
the first wirings, the second wirings, and the third wirings are disposed in one layer without crossing one another.

10. The mounting board according to claim 4, further comprising a first detection circuit provided on the wiring substrate and detecting a temperature of the mounting board,
wherein any of the driver circuits reduces or stops, based on an output of the first detection circuit, an output of the driver circuit.

11. The mounting board according to claim 4, further comprising a second detection circuit provided on the wiring substrate and detecting a presence of electrical connection between the driver IC and each of the light modulation elements,
wherein any of the driver circuits reduces or stops, based on an output of the second detection circuit, an output of the driver circuit.

12. A display unit, comprising:
a plurality of light modulation elements each performing light modulation on received light in response to an applied voltage; and
a mounting board including a single driver IC mounted on a circuit substrate, the driver IC driving the light modulation elements,
wherein the mounting board includes
a plurality of driver circuits that are individually provided for the respective light modulation elements, and drive the light modulation elements, and
a plurality of output terminals outputting signals derived from the respective driver circuits to outside, the output terminals being disposed on sides of the driver IC, and the respective output terminals being disposed on the different sides for the respective corresponding driver circuits.

13. A projection display unit, comprising:
an illumination optical system;
a plurality of light modulation elements each generating image light through modulation of light derived from the illumination optical system in response to an applied voltage;
a mounting board including a single driver IC mounted on a circuit substrate, the driver IC driving the light modulation elements; and
a projection optical system projecting the image light generated by the light modulation elements,
wherein the mounting board includes
a plurality of driver circuits that are individually provided for the respective light modulation elements, and drive the light modulation elements, and
a plurality of output terminals outputting signals derived from the respective driver circuits to outside, the output terminals being disposed on sides of the driver IC, and the respective output terminals being disposed on the different sides for the respective corresponding driver circuits.
